(19) United States
(12) Patent Application Publication
(10) Pub. No.: US 2026/0169251 A1
(43) Pub. Date: Jun. 18, 2026

(54) OPTICAL APPARATUS, SYSTEM, MOVABLE APPARATUS, AND MANUFACTURING METHOD OF OPTICAL APPARATUS

(71) Applicant: CANON KABUSHIKI KAISHA, Tokyo (JP)

(72) Inventor: AYUMU KAMEOKA, Saitama (JP)

(21) Appl. No.: 19/411,799

(22) Filed: Dec. 8, 2025

(30) Foreign Application Priority Data
Dec. 16, 2024 (JP) 2024-220287

(51) Int. Cl. G02B 7/02

(52) U.S. Cl. CPC G02B 7/025

(57) ABSTRACT

An optical apparatus includes a first holder that holds a first element, and a second holder that holds a second element. The first holder has a first adhesive surface. The second holder has a second adhesive surface and a third adhesive surface facing the first adhesive surface. The first adhesive surface and the second adhesive surface are adhered to each other by a first adhesive. The first adhesive surface and the third adhesive surface are adhered to each other by a second adhesive. A first linear expansion coefficient of the first adhesive and a second linear expansion coefficient of the second adhesive are different from each other. A first thickness of the first adhesive in a first direction and a second thickness of the second adhesive in the first direction may be different from each other.

### BACKGROUND

### Field of the Technology

The disclosure relates to one or more embodiments of an optical apparatus, a system, a movable apparatus, and a manufacturing method of an optical apparatus.

### Description of the Related Art

Japanese Patent Application Laid-Open No. 2021-185398 discloses a method for manufacturing a lens unit in which an imaging lens and an image sensor are fixed together by adjusting the position of the imaging surface of the image sensor relative to the imaging lens and then curing an ultraviolet (UV) curable adhesive and a thermosetting adhesive (heat curable adhesive).

### SUMMARY

One or more embodiments of an optical apparatus according to one or more aspects of the disclosure may include a first holder that holds a first element, and a second holder that holds a second element. The first holder may have a first adhesive surface. The second holder may have a second adhesive surface and a third adhesive surface facing the first adhesive surface. The first adhesive surface and the second adhesive surface may be adhered to each other by a first adhesive. The first adhesive surface and the third adhesive surface may be adhered to each other by a second adhesive. A first linear expansion coefficient of the first adhesive and a second linear expansion coefficient of the second adhesive may be different from each other. A first thickness of the first adhesive in a first direction and a second thickness of the second adhesive in the first direction may be different from each other A system and a movable unit each including the above optical apparatus also constitute another aspect of the disclosure.

One or more embodiments of a method for manufacturing an optical apparatus according to one or more aspects of the disclosure may include applying a first adhesive between a first adhesive surface of a first holder that holds a first element and a second adhesive surface of a second holder that holds a second element, the second adhesive surface facing the first adhesive surface, applying a second adhesive between the first adhesive surface and a third adhesive surface of the second holder, adjusting relative positions of the first holder and the second holder, curing the first adhesive, and curing the second adhesive. A first linear expansion coefficient of the first adhesive and a second linear expansion coefficient of the second adhesive may be different from each other. A first thickness of the first adhesive and a second thickness of the second adhesive in a first direction may be different from each other.

Features of the present disclosure will become apparent from the following description of embodiments with reference to the attached drawings. The following description of embodiments will be described by way of example.

### BRIEF DESCRIPTION OF THE DRAWINGS

FIG. 1 is a block diagram of an image pickup apparatus according to a first embodiment.

FIG. 2 is a schematic sectional view of the image pickup apparatus according to the first embodiment.

FIG. 3 is a schematic diagram of an image pickup apparatus according to a second embodiment.

FIG. 4 is a flowchart illustrating a manufacturing method of the image pickup apparatus according to each embodiment.

FIG. 5 is a functional block diagram of a system having the image pickup apparatus according to each embodiment.

FIG. 6 is a schematic diagram of the main parts of a movable apparatus having the image pickup apparatus according to each embodiment.

FIG. 7 is a flowchart illustrating an example of the operation of a system having image pickup apparatus according to each embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a description will be given of embodiments according to the disclosure.

### First Embodiment

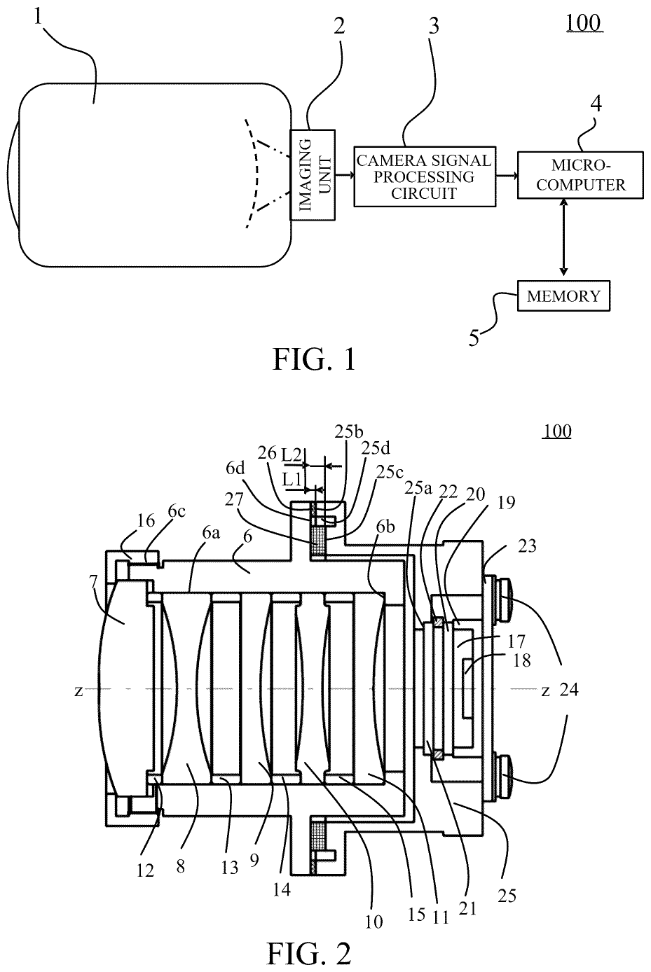

Referring now to FIG. 1, a description will be given of an image pickup apparatus (optical apparatus) 100 according to a first embodiment of the disclosure. FIG. 1 is a block diagram of the image pickup apparatus according to this embodiment. The image pickup apparatus 100 includes a lens unit 1, an imaging unit (imaging module) 2, a camera signal processing circuit 3, a microcomputer (control unit) 4, and a memory (storage unit) 5.

The imaging unit 2 is fixed to the lens unit 1. The camera signal processing circuit 3 processes an output signal (captured signal) from the imaging unit 2. The camera signal processing circuit 3 amplifies and corrects the output signal from the imaging unit 2, for example. The image signal amplified and corrected by the camera signal processing circuit 3 is output to the microcomputer 4. The microcomputer 4 recognizes an object based on the data stored in the memory 5.

The basic configuration of FIG. 1 is similarly applicable to a second embodiment described below. The image pickup apparatus according to each embodiment is used, for example, as an on-board (in-vehicle) sensing camera, but is not limited to this example and can also be used for other purposes, such as a surveillance camera.

Next, the structure of the image pickup apparatus 100 according to this embodiment will be described with reference to FIG. 2. FIG. 2 is a schematic sectional view of the lens unit 1 and imaging unit 2 that constitute the image pickup apparatus 100.

The barrel (first holder) 6 holds the optical elements that constitute the imaging optical system. In this embodiment, the imaging optical system has lenses 7, 8, 9, 10, and 11 (optical elements, first elements) arranged in this order from the object side to the image side. Spacers 12, 13, 14, and 15 are provided to maintain a constant distance between adjacent lenses in the direction along the optical axis (Z-Z) (optical axis direction, first direction). The spacer 12 is provided between the lenses 7 and 8. The spacer 13 is provided between the lenses 8 and 9. The spacer 14 is provided between the lenses 9 and 10. The spacer 15 is provided between the lenses 10 and 11. The lenses and spacers described above are fitted radially into an inner diameter portion 6a of the barrel 6 and are fixed in a state where they are biased in the optical axis direction against a security surface 6b by a press ring 16 that is screwed with a threaded portion 6c.

The image sensor (second element) 18 is sealed by a case portion 19 and a protective glass 20, forming the imaging unit 17. The imaging unit 17 is soldered to a printed circuit board 23, forming the imaging unit 2. A sensor holder (second holder) 25 has a stepped portion with a security surface 25a that determines its position in the optical axis direction. An optical filter 21 includes a low-pass filter, infrared cut filter, or the like, and is fixed in close contact with the security surface 25a by a sealing member 22. The imaging unit 2 is fixed to the lens unit 1 by fastening the printed circuit board 23 to the sensor holder 25 with screws 24. The space formed by the protective glass 20 and the optical filter 21 is sealed by the sealing member 22, preventing the intrusion of floating debris and dust.

The barrel 6 has an adhesive surface (first adhesive surface) 6d extending orthogonal to the optical axis (Z-Z). Facing the adhesive surface 6d, the sensor holder 25 has an outer adhesive surface (second adhesive surface) 25b, an inner adhesive surface (third adhesive surface) 25c, and a groove 25d for collecting excess adhesive. The adhesive surfaces 25b and 25c are stepped relative to each other in the optical axis direction so that the adhesive surfaces 25b and 25c are located at different positions in the optical axis direction. The groove 25d between the adhesive surfaces 25b and 25c is not essential; there may be a step between the adhesive surfaces 25b and 25c. In this embodiment, the sensor holder 25 may have the first adhesive surface, and the barrel 6 may have the second and third adhesive surfaces (the sensor holder 25 may be the first holder, and the barrel 6 may be the second holder).

A UV curable adhesive (first adhesive) 26 in an uncured state is continuously applied between the adhesive surfaces 6d and 25b. A thermosetting adhesive (second adhesive) 27 in an uncured state is continuously applied between the adhesive surfaces 6d and 25c. The UV curable adhesive 26 and the thermosetting adhesive 27 are disposed (applied side by side in the second direction) in a direction orthogonal to the optical axis direction (radial direction, second direction). The UV curable adhesive 26 is arranged farther from the optical axis than the thermosetting adhesive 27.

In this embodiment, the UV curable adhesive 26 and the thermosetting adhesive 27 have different curing speeds. The thermosetting adhesive 27 has a curing speed lower than that of the UV curable adhesive 26. For example, the UV curable adhesive 26 cures in about 5 seconds, while the thermosetting adhesive 27 cures in 30 minutes or more.

In order to adjust the imaging unit 2 relative to the in-focus position of the lens unit 1, the sensor holder 25 is held in midair and its position is adjusted by an adjustment device (not illustrated). The adjustment of the imaging unit 2 is made by adjusting its position in the optical axis direction and its eccentricity and tilt in a direction orthogonal to the optical axis, and by irradiating UV light onto the UV curable adhesive 26 to cure it. Thereby, the image sensor 18 is fixed at a proper position and the space between the barrel 6 and the sensor holder 25 is sealed.

After the UV curable adhesive 26 is cured (first curing), the lens unit 1 with the imaging unit 2 fixed in position is moved to a heating furnace or the like, and the thermosetting adhesive 27 is cured (second curing) by heating at 80° C. or higher. In this embodiment, the application area of the thermosetting adhesive 27 (the second area where the thermosetting adhesive 27 is applied to the adhesive surface 25c) may be larger than the application area of the UV curable adhesive 26 (the first area where the UV curable adhesive 26 is applied to the adhesive surface 25b). This ensures full curing of the thermosetting adhesive 27.

A description will now be given of a change amount in the adhesive coating thickness with temperature change for each adhesive. In this embodiment, the following inequality may be satisfied:

$$α 1 > α 2$$

where α1 is a linear expansion coefficient (first linear expansion coefficient) of the UV curable adhesive 26, and α2 is a linear expansion coefficient (second linear expansion coefficient) of the thermosetting adhesive 27.

Here, L1 is a coating thickness (first thickness) of the UV curable adhesive 26, i.e., a distance in the optical axis direction (first direction) between the adhesive surface 6d of the barrel 6 and the adhesive surface 25b of the sensor holder 25. L2 is a coating thickness (second thickness) of the thermosetting adhesive 27, i.e., a distance in the optical axis direction between the adhesive surface 6d of the barrel 6 and the adhesive surface 25c of the sensor holder 25. T1 is a predetermined temperature, and T2 is a temperature after a temperature change from T1.

The change amount in the coating thickness of each adhesive in the optical axis direction with temperature change can be calculated as follows using the linear expansion coefficient and coating thickness of each adhesive. That is, for the UV curable adhesive 26, this can be calculated as:

$$α 1 \times L 1 \times ( T 2 - T 1 ) = α1 \cdot L 1 \cdot ( T 2 - T 1 )$$

Similarly, for the thermosetting adhesive 27, this can be calculated as:

$$α 2 \times L 2 \times ( T 2 - T 1 ) = α2 \cdot L 2 \cdot ( T 2 - T 1 )$$

The relationship between the linear expansion coefficients of the UV curable adhesive 26 and the thermosetting adhesive 27 satisfies the following inequality:

$$α 1 > α 2$$

Therefore, in a case where L1=L2, the change amount in coating thickness will be as follows:

$$α 1 \times L 1 \times ( T 2 - T 1 ) > α 2 \times L 2 \times ( T 2 - T 1 )$$

Therefore, if only the thermosetting adhesive 27, which has a low linear expansion coefficient, is applied, the deformation will be limited to α2×L2×(T2−T1). However, in this embodiment, in addition to the thermosetting adhesive 27, the UV curable adhesive 26, which has a high linear expansion coefficient, is also applied. Thus, the thermosetting adhesive 27 attempts to deform by an additional amount equal to α1×L1×(T2−T1)−α2×L2×(T2−T1). This excessive deformation could result in peeling of the adhesive.

Accordingly, in this embodiment, so as to prevent adhesive peeling, a deformation amount of each adhesive when the temperature changes is matched. In other words, ideally, by satisfying the relationship α1×L1×(T2−T1)−α2×L2×(T2−T1), the relationship L2=L1×α1/α2 can be derived. This relationship can be achieved by providing a step between the adhesive surfaces 25b and 25c relative to the optical axis (Z-Z), which prevents adhesive peeling. In this embodiment, α1>α2, and therefore the relationship L1<L2 is satisfied (the second thickness is greater than the first thickness). However, this embodiment is not limited to this example, and in a case where α1<α2, the relationship L1>L2 is satisfied (the first thickness is greater than the second thickness).

This embodiment is not limited to the configuration that satisfies the above inequality. The following inequality (1) may be satisfied:

$$0.8 \leq ( α 1 \times L 1 ) / ( α2 \times L 2 ) \leq 1.2 \qquad ( 1 )$$

Inequality (1) may be replaced with inequality (1a) below:

$$0.9 \leq ( α 1 \times L 1 ) / ( α2 \times L 2 ) \leq 1.10 \qquad ( 1 a )$$

Inequality (1) may be replaced with inequality (1b) below:

$$0.95 \leq ( α 1 \times L 1 ) / ( α2 \times L 2 ) \leq 1.05 \qquad ( 1 b )$$

The lens unit 1 assembled in this embodiment can maintain dustproof and weatherproof performance and optical performance even in harsh environments such as in vehicle (on board) use.

### Second Embodiment

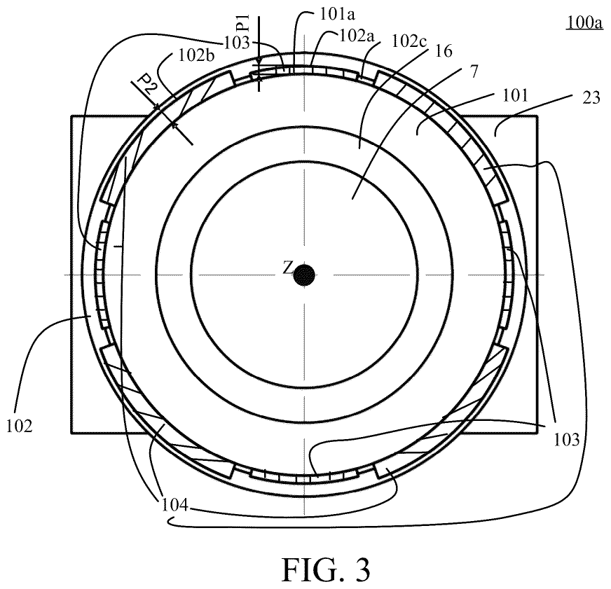

Referring now to FIG. 3, a description will be given of a second embodiment according to the disclosure. FIG. 3 is a schematic diagram of an image pickup apparatus (optical apparatus) 100a according to this embodiment, illustrating the image pickup apparatus 100a viewed from the object side along the optical axis direction (second direction). This embodiment will omit a description of parts similar to those in the first embodiment, and will discuss differences from the first embodiment, namely, the adhesive location between the barrel and the sensor holder.

The barrel (first holder) 101 has an adhesive surface (first adhesive surface) 101a that extends in a circumferential direction of the barrel 101 relative to the optical axis (Z-Z). A sensor holder (second holder) 102 has an adhesive surface (second adhesive surface) 102a and adhesive surface (third adhesive surface) 102b facing the adhesive surface 101a, and a groove 102c for collecting excess adhesive. The adhesive surfaces 102a and 102b form a step in a direction orthogonal to the optical axis (radial direction, first direction) (the adhesive surfaces 102a and 102b are located at different positions in the radial direction).

A UV curable adhesive (first adhesive) 103 in an uncured state is applied partially between the adhesive surfaces 101a and 102a. A thermosetting adhesive (second adhesive) 104 in an uncured state is applied partially between the adhesive surfaces 101a and 102b. The UV curable adhesive 103 and thermosetting adhesive 104 are arranged in a direction orthogonal to the optical axis direction (circumferential direction, second direction) (applied side by side in the second direction).

Next follows a description of a change amount in the coating thickness of each adhesive along with temperature changes. In this embodiment, the following inequality is satisfied:

$$β 1 > β 2$$

where β1 is a linear expansion coefficient of the UV curable adhesive 103, and β2 is a linear expansion coefficient of the thermosetting adhesive 104.

Here, P1 is a coating thickness (first thickness) of the UV curable adhesive 103, i.e., a distance (radial difference) in the direction orthogonal to the optical axis (first direction) between the adhesive surface 101a of the barrel 101 and the adhesive surface 102a of the sensor holder 102. P2 is a coating thickness (second thickness) of the thermosetting adhesive 104, i.e., the distance (radial difference) in the direction orthogonal to the optical axis between the adhesive surface 101a of the barrel 101 and the adhesive surface 102a of the sensor holder 102.

T3 is a predetermined temperature, and T4 is a temperature after the temperature change from T3. A change amount in the coating thickness of each adhesive in the optical axis direction with temperature change can be calculated as follows using the linear expansion coefficient and coating thickness of each adhesive. That is, for the UV curable adhesive 103, this can be calculated as:

$$β 1 \times P 1 \times ( T 4 - T 3 ) = β1 \cdot P 1 \cdot ( T 4 - T 3 )$$

Similarly, for the thermosetting adhesive 104, this can be calculated as:

$$β 2 \times P 2 \times ( T 4 - T 3 ) = β2 \cdot P 2 \cdot ( T 4 - T 3 )$$

The relationship between the linear expansion coefficients of the UV curable adhesive 103 and the thermosetting adhesive 104 satisfies the following inequality:

$$β 1 > β 2$$

Therefore, in this embodiment as well, so as to prevent adhesive peeling, a deformation amount of each adhesive when temperature changes is matched. In other words, by satisfying the relationship β1×P1×(T4−T3)−β2×P2×(T4−T3), the relationship P2=P1×β1/β2 can be derived. This relationship can be achieved by providing a diameter difference between the adhesive surfaces 102a and 102b relative to the optical axis (Z-Z), which prevents adhesive peeling. In this embodiment, β1>82, and therefore the relationship P1<P2 is satisfied.

However, this embodiment is not limited to this example, and the following inequality (2) may be satisfied.

$$0.8 \leq ( β 1 \times P 1 ) / ( β2 \times P 2 ) \leq 1.2 \qquad ( 2 )$$

Inequality (2) may be replaced with inequality (2a) below:

$$0.9 \leq ( β 1 \times P 1 ) / ( β2 \times P 2 ) \leq 1.10 \qquad ( 2 a )$$

Inequality (2) may be replaced with inequality (2b) below:

$$0.95 \leq ( β 1 \times P 1 ) / ( β2 \times P 2 ) \leq 1.05 \qquad ( 2 b )$$

Each embodiment uses the UV curable adhesive 26 (103) and the thermosetting adhesive 27 (104), but at least one of these adhesives may be replaced with a UV curable and thermosetting adhesive (dual bond) or a natural curing adhesive.

While the imaging unit 17 attaches the printed circuit board 23 to the sensor holder 25 (102) with the screw member 24, a structure that adheres and fixes the case portion 19 to the sensor holder 25 (102).

In each embodiment, the optical apparatus is the image pickup apparatus having the lens unit and imaging unit, but this embodiment is not limited to this example and is similarly applicable to another apparatus that includes a first optical member and a second optical member whose relative positions require adjustment.

### Method of Manufacturing Image Pickup Apparatus

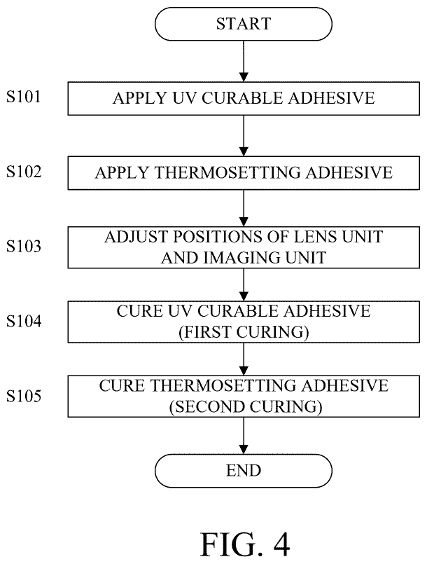

Next, a method of manufacturing the image pickup apparatus according to each embodiment will be described with reference to FIG. 4. FIG. 4 is a flowchart illustrating the method of manufacturing the image pickup apparatus. First, in step S101, the UV curable adhesive 26 (103) is applied between the adhesive surface (first adhesive surface) 6d of the barrel 6 (101) and the adhesive surface (second adhesive surface) 25b (102a) of the sensor holder 25 (102) (first application step). Next, in step S102, the thermosetting adhesive 27 (104) is applied between the adhesive surface (first adhesive surface) 6d of the barrel 6 (101) and the adhesive surface (third adhesive surface) 25c (102b) of the sensor holder 25 (102) (second application step).

In the first application step, a UV curable/thermosetting adhesive (dual bond) that cures with both UV and heat may be used instead of the UV curable adhesive 26 (103). That is, in the first application step, the adhesive surfaces can be adhered together using at least the adhesive (first adhesive) that is curable by UV light.

In the second application step, instead of the thermosetting adhesive 27 (104), an UV curable/thermosetting adhesive (dual bond) that cures with both UV light and heat may be used. That is, in the second application step, the adhesive surfaces can be adhered together using at least the adhesive (second adhesive) that is curable by heat.

The order of the first and second application steps may be reversed. Alternatively, the first and second application steps may be performed simultaneously.

Next, in step S103, the relative positions of the barrel 6 (101) and the sensor holder 25 (102) are adjusted (position adjustment step). In the position adjustment step, the barrel 6 (101) and the sensor holder 25 (102) are held by the arm of the adjustment device, and their relative positions are adjusted to satisfy predetermined optical performance. That is, the image pickup apparatus 100 (100a) adjusts the position of the image sensor 18 relative to the lenses 7, 8, 9, 10, and 11 while holding the barrel 6 (101) and sensor holder 25 (102) in midair using the adjustment device.

Next, in step S104, the UV curable adhesive 26 (103) is cured with UV light (temporarily or first curing step). This temporarily fixes the barrel 6 (101) and sensor holder 25 (102) whose positions were adjusted in the position adjustment step. Next, in step S105, the thermosetting adhesive 27 (104) is cured with heat (full or second curing step).

Each embodiment can provide an optical apparatus that can suppress peeling of a plurality of adhesives due to temperature changes.

### System

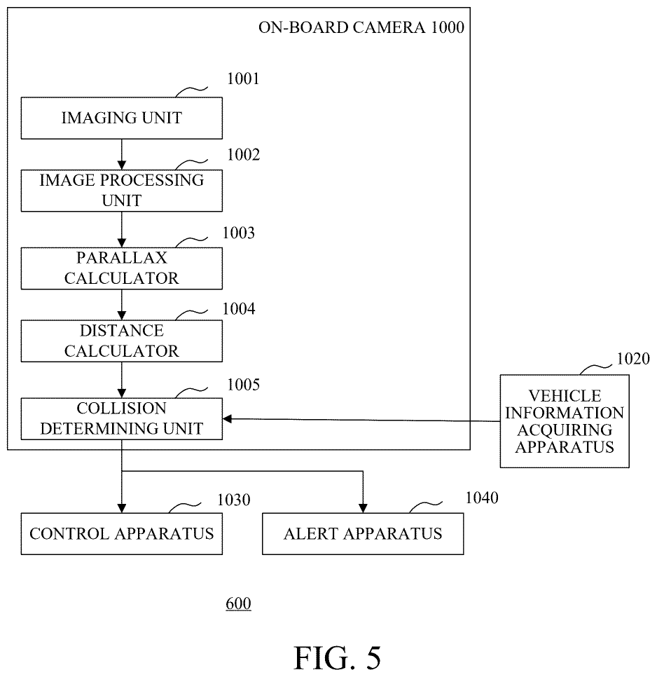

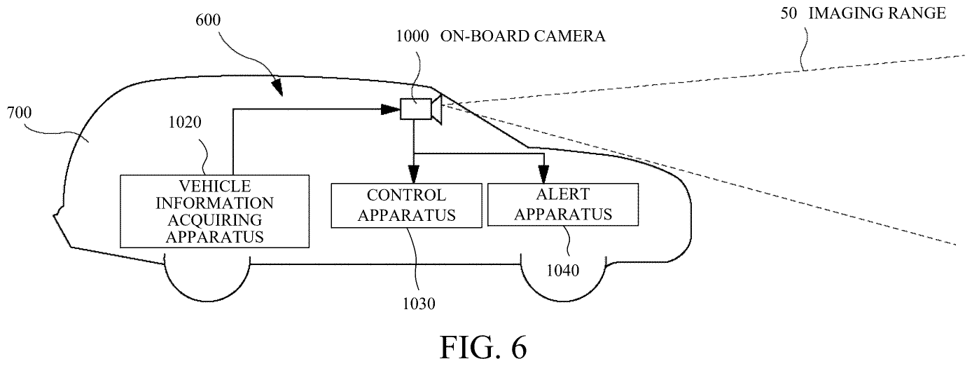

FIG. 5 is a configuration diagram of an on-board (in-vehicle) camera (image pickup apparatus) 1000 and a system (on-board (in-vehicle) system, control system, driving assistance apparatus) 600 having it according to this embodiment. The on-board camera 1000 corresponds to the image pickup apparatus 100 (100a) in each of the above embodiments. The system 600 is held by a movable apparatus such as an automobile (vehicle) and is a system for assisting the driving (operation) of the vehicle based on image information on the surroundings of the vehicle acquired by the on-board camera 1000. FIG. 6 is a schematic diagram of a vehicle 700 as a movable apparatus having the system 600. In FIG. 6, an imaging range 50 of the on-board camera 1000 is set to the front of the vehicle 700, but may be set to the back or side of the vehicle 700.

As illustrated in FIG. 5, the system 600 includes the on-board camera 1000, a vehicle information acquiring apparatus 1020, a control apparatus (control unit, Electronic Control Unit: ECU) 1030, and an alert (or warning) apparatus (alert or warning unit) 1040. The on-board camera 1000 also includes an imaging unit 1001, an image processing unit 1002, a parallax calculator 1003, a distance acquiring unit (acquiring unit) 1004, and a collision determining unit 1005. The image processing unit 1002, the parallax calculator 1003, the distance acquiring unit 1004, and the collision determining unit 1005 constitute a processing unit. The imaging unit 1001 includes an optical system according to any of the above embodiments and an image sensor.

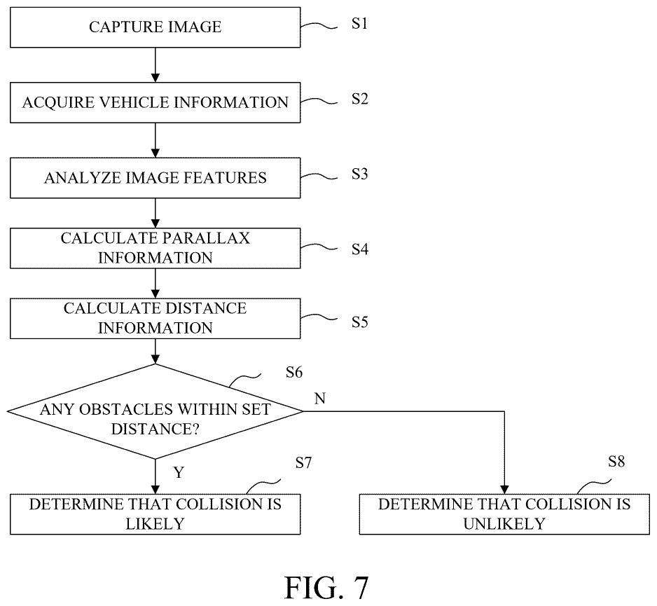

FIG. 7 is a flowchart illustrating an example of the operation of the system 600 according to this embodiment. The operation of the system 600 will be described below with reference to this flowchart.

First, in step S1, the imaging unit 1001 captures an image of an object such as an obstacle and pedestrian around the vehicle, and acquires multiple image data (parallax image data).

In step S2, vehicle information is acquired by the vehicle information acquiring apparatus 1020. The vehicle information includes the speed, yaw rate, steering angle of the vehicle, and the like.

In step S3, the image processing unit 1002 performs image processing for the multiple image data acquired by the imaging unit 1001. More specifically, image feature analysis is performed to analyze feature amounts such as an amount and direction of an edge in the image data and density value. Here, image feature analysis may be performed for each of the multiple image data, or on only part the multiple image data.

In step S4, the parallax calculator 1003 calculates parallax (image shift) information between the multiple image data acquired by the imaging unit 1001. Known methods such as the SSDA method and area correlation method can be used to calculate parallax information, so a description of these methods will be omitted in this embodiment. Steps S2, S3, and S4 may be performed in the order described above, or may be processed in parallel with each other.

In step S5, the distance acquiring unit 1004 acquires (calculates) distance information to the object imaged by the imaging unit 1001. The distance information can be calculated based on the parallax information calculated by the parallax calculator 1003 and the internal and external parameters of the imaging unit 1001. The distance information here refers to information on the relative position of the object, such as the distance to the object, the defocus amount, and the image shift amount, and may directly represent the distance value of the object in the image, or may indirectly represent information corresponding to the distance value.

In step S6, the collision determining unit 1005 uses the vehicle information acquired by the vehicle information acquiring apparatus 1020 and the distance information calculated by the distance acquiring unit 1004 to determine whether the distance to the object is within a predetermined distance range. This makes it possible to determine whether an object exists within a set distance around the vehicle and determine the likelihood (possibility of a collision between the vehicle and the object. The collision determining unit 1005 determines that there is a “likelihood of collision” in a case where an object is present within the set distance (step S7), and determines that there is no “likelihood of collision” in a case where there is no object within the set distance (step S8).

Next, in a case where the collision determining unit 1005 determines that there is a “likelihood of collision,” it notifies (transmits) the determination result to the control apparatus 1030 and the alert apparatus 1040. At this time, the control apparatus 1030 controls the vehicle based on the determination result of the collision determining unit 1005 (step S6), and the alert apparatus 1040 alerts the vehicle user (driver, passengers) based on the determination result of the collision determining unit 1005 (step S7). The notification of the determination result may be sent to at least one of the control apparatus 1030 and the alert apparatus 1040.

The control apparatus 1030 can control the movement of the vehicle by outputting a control signal to the drive unit (engine, motor, etc.) of the vehicle. For example, the control apparatus 1030 controls the vehicle by applying the brakes, releasing the accelerator, turning the steering wheel, or generating control signals to generate braking force on each wheel to suppress the output of the engine or motor. The alert apparatus 1040 also alerts the user by, for example, sounding an alarm (alarm), displaying alert information on a screen such as a car navigation system, or vibrating the seat belt or steering wheel.

As described above, the system 600 according to this embodiment effectively detects an object through the above processing, and can avoid any collisions between the vehicle and the object. In particular, applying the optical systems according to the above embodiment to the system 600 can reduce the overall size of the on-board camera 1000, increase the degree of freedom in arrangement, detect an object over a wide angle of view, and determine any collisions between the vehicle and the object.

A variety of embodiments are conceivable for acquiring distance information. As an example, a case will be described in which a pupil division type image sensor having a plurality of pixels regularly arranged in a two-dimensional array is used as the image sensor of the imaging unit 1001. In a pupil division type image sensor, one pixel unit includes a microlens and a plurality of photoelectric converters, and can receive a pair of light beams that pass through different areas in the pupil of the optical system, and output a pair of image data from the respective photoelectric converters.

An image shift amount in each area is calculated by a correlation calculation between the pair of image data, and the distance acquiring unit 1004 calculates image shift map data that represents the distribution of the image shift amounts. Alternatively, the distance acquiring unit 1004 may further convert the image shift amount into a defocus amount to generate defocus map data that represents the distribution of the defocus amount (distribution on a two-dimensional plane of the captured image). The distance acquiring unit 1004 may also acquire distance map data of the distance to the object converted from the defocus amount.

The system 600 and the vehicle (movable apparatus) 700 may further include a notification apparatus (notification unit) that notifies the system manufacturer or the distributor (dealer) of the movable apparatus in the event that the vehicle 700 collides with an obstacle. For example, the notification apparatus may be one that transmits information on a collision between the vehicle 700 and an obstacle (collision information) to a previously set external notification destination via email or the like.

Automatic notification of the collision information using the notification apparatus in this way can promptly take measures such as inspection and repair after a collision occurs. The destination of the collision information may be an insurance company, a medical institution, the police, or any other entity set by the user. The notification apparatus may also be configured to notify the destination of not only collision information but also information about malfunctions of various components and information about the consumption of consumables. The presence or absence of a collision may be detected using distance information acquired based on the output from the above imaging unit 1001 (imaging unit 2), or by another detector (sensor).

While the system 600 is applied to driving assistance (collision damage mitigation) in this embodiment, the system 600 is not limited to this application. The system 600 may also be applied to other movable units, such as ships, aircraft, and industrial robots. The disclosure can be applied not only to movable units but also to various devices that utilize object recognition, such as intelligent transport systems (ITS).

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment can provide an optical apparatus that can prevent peeling of multiple adhesives due to temperature changes.

This application claims the benefit of Japanese Patent Application No. 2024-220287, filed on Dec. 16, 2024, and which is hereby incorporated by reference herein in its entirety.

What is claimed is:

1. An optical apparatus comprising:
a first holder that holds a first element; and
a second holder that holds a second element,
wherein the first holder has a first adhesive surface,
wherein the second holder has a second adhesive surface and a third adhesive surface facing the first adhesive surface,
wherein the first adhesive surface and the second adhesive surface are adhered to each other by a first adhesive,
wherein the first adhesive surface and the third adhesive surface are adhered to each other by a second adhesive,
wherein a first linear expansion coefficient of the first adhesive and a second linear expansion coefficient of the second adhesive are different from each other, and
wherein a first thickness of the first adhesive in a first direction and a second thickness of the second adhesive in the first direction are different from each other.

2. The optical apparatus according to claim 1, wherein the second adhesive surface and the third adhesive surface are disposed at different positions from each other in the first direction.

3. The optical apparatus according to claim 1, wherein the following inequality is satisfied:
$$0.8 \leq ( α 1 \times L 1 ) / ( α2 \times L 2 ) \leq 1.2$$
where α1 is the first linear expansion coefficient, α2 is the second linear expansion coefficient, L1 is the first thickness, and L2 is the second thickness.

4. The optical apparatus according to claim 1, wherein a groove is provided between the second adhesive surface and the third adhesive surface.

5. The optical apparatus according to claim 1, wherein the first direction is an optical axis direction.

6. The optical apparatus according to claim 1, wherein the first direction is a direction orthogonal to an optical axis direction.

7. The optical apparatus according to claim 1, wherein the first adhesive and the second adhesive are arranged along a second direction orthogonal to the first direction.

8. The optical apparatus according to claim 1, wherein the first adhesive and the second adhesive have different curing speeds.

9. The optical apparatus according to claim 8, wherein a curing speed of the second adhesive is lower than a curing speed of the first adhesive, and
wherein a second area where the second adhesive is applied to the third adhesive surface is larger than a first area where the first adhesive is applied to the second adhesive surface.

10. The optical apparatus according to claim 8, wherein the first adhesive is an ultraviolet curable adhesive.

11. The optical apparatus according to claim 8, wherein the second adhesive is a thermosetting adhesive.

12. The optical apparatus according to claim 8, wherein the first adhesive is positioned farther from an optical axis than the second adhesive.

13. The optical apparatus according to claim 1, wherein the second thickness is greater than the first thickness.

14. The optical apparatus according to claim 1, wherein the first thickness is greater than the second thickness.

15. The optical apparatus according to claim 1, wherein the first element is an optical element, and
wherein the second element is an image sensor.

16. The optical apparatus according to claim 1, wherein the first element is an image sensor, and
wherein the second element is an optical element.

17. A system comprising:
the optical apparatus according to claim 1;
one or more memories storing instructions; and
one or more processors that, upon execution of the instructions, operate to determine a likelihood of collision between a movable apparatus and an object based on distance information on the object obtained based on an output of the optical apparatus.

18. A movable apparatus comprising:
the optical apparatus according to claim 1,
wherein the movable apparatus can hold the optical apparatus and move.

19. A method for manufacturing an optical apparatus comprising:
applying a first adhesive between a first adhesive surface of a first holder that holds a first element and a second adhesive surface of a second holder that holds a second element, the second adhesive surface facing the first adhesive surface;
applying a second adhesive between the first adhesive surface and a third adhesive surface of the second holder;
adjusting relative positions of the first holder and the second holder;
curing the first adhesive; and
curing the second adhesive,
wherein a first linear expansion coefficient of the first adhesive and a second linear expansion coefficient of the second adhesive are different from each other, and
wherein a first thickness of the first adhesive in a first direction and a second thickness of the second adhesive in the first direction are different from each other.

20. The method according to claim 19, wherein adjusting the relative positions enables the optical apparatus to satisfy predetermined optical performance.
